(19) United States
(12) Patent Application Publication
(10) Pub. No.: US 2002/0177397 A1
(43) Pub. Date: Nov. 28, 2002

(54) Portable worktop

(76) Inventor: David P. Smith, Mobile, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 10/156,296

(22) Filed: May 28, 2002

Related U.S. Application Data
(60) Provisional application No. 60/293,201, filed on May 25, 2001.
(60) Provisional application No. 60/293,202, filed on May 25, 2001.

(51) Int. Cl. A22B 1/00

(52) U.S. Cl. 452/185; 452/198

(57) ABSTRACT

A portable worktop that may be used for cleaning, preparing, or serving food has been developed. The portable worktop includes a work surface with an opening in the work surface. The worktop is held in place on a stable supporting base by a fastening ring. The opening is positioned over the supporting base so that the opening may be used for waste disposal.

### CROSS-REFERENCE TO RELATED APPLICATIONS

This application claims priority from U.S. Provisional Application 60/293,201 filed on May 25, 2001 and U.S. Provisional Application 60/293,202 filed on May 25, 2001.

### BACKGROUND OF INVENTION

1. Field of the Invention

The invention relates generally to a worktop. More specifically, the invention relates to a portable worktop with an integrated opening for waste disposal.

2. Background Art

The cleaning and preparation of foods such as fish, meat, or vegetables, typically generates some waste debris. The disposal of this waste is often messy and inconvenient. An apparatus is needed that provides a stable working environment while allowing easy and neat disposal of any waste products.

### SUMMARY OF INVENTION

In some aspects, the invention relates to a worktop, comprising: a work surface; an opening in the work surface; and a fastening ring that detachably holds the worktop onto a stable base that completely supports the worktop, where the opening in the work surface is over the base so that the opening may be used for waste disposal.

In other aspects, the invention relates to a worktop, comprising: a work surface; means for disposing of waste material through the work surface; and means for detachably supporting the worktop.

Other aspects and advantages of the invention will be apparent from the following description and the appended claims.

### BRIEF DESCRIPTION OF DRAWINGS

It should be noted that identical features in different drawings are shown with the same reference numeral.

FIG. 1A shows an overhead view of one embodiment of the present invention.

FIG. 1B shows a bottom view of the embodiment of the present invention shown in FIG. 1A.

FIG. 1C shows a side view of the embodiment of the present invention shown in FIGS. 1A and 1B.

FIG. 2A shows an overhead view of a cover for the opening for use with the embodiment of the present invention shown in FIGS. 1A-1C.

FIG. 2B shows a side view of the cover shown in FIG. 2A.

FIG. 3A shows an overhead view of an alternative embodiment of the present invention.

FIG. 3B shows a bottom view of the alternative embodiment of the present invention shown in FIG. 3A.

FIG. 3C shows a side view of the alternative embodiment of the present invention shown in FIGS. 3A and 3B.

FIG. 4A shows an overhead view of a cover for the opening for use with the embodiment of the present invention shown in FIGS. 3A-3C.

FIG. 4B shows a side view of the cover shown in FIG. 3A.

### DETAILED DESCRIPTION

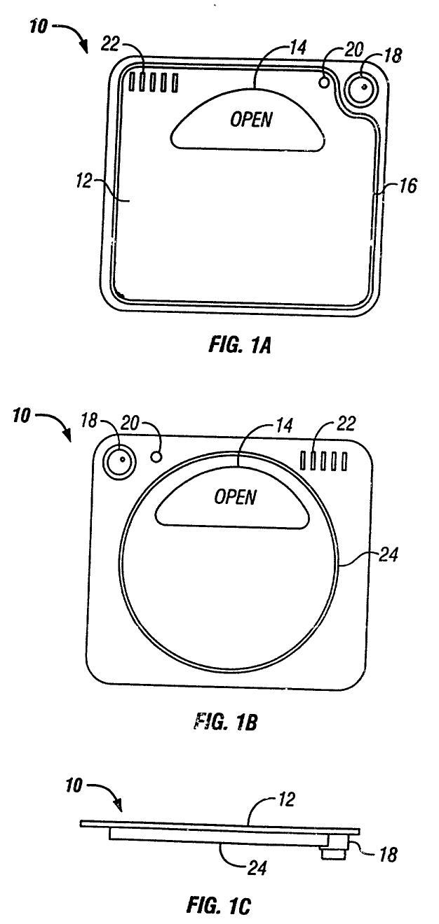

FIG. 1A shows an overhead view of one embodiment of a portable worktop 10. The worktop 10 has a work surface 12 that is used to clean and prepare foods such as fish, meat, or vegetables. A portion of the worktop 10 is an opening 14 that is positioned over a garbage can or other type of waste receptacle.

The worktop 12 and the opening 14 are surrounded by a drainage channel 16 along the edge of the worktop 10. The channel 16 contains any liquid waste or rising water and prevents it from running off the side of the worktop 10. Multiple slots 22 are formed in the worktop 10 to hold utensils, such as knives, when they are not in use. An opening for a water hose 20 is also present. The hose is used to rinse and clean the work surface 12. Finally, a cupholder 18 is present. The cupholder 18 is self-draining through a hole that is located in the bottom.

FIG. 1B shows a bottom view of one embodiment of the worktop 10. The features previously shown on the overhead view are present such as the opening 14, the cupholder 18, the hose opening 20, and the utensil slots 22. Also shown in this view is a fastening ring 24 that fits on the open top of a waste receptacle. The ring may fit around the outer edge of the receptacle or inside the outer edge depending on its size. In an alternative embodiment, the fastening ring may be broken into individual separate segments that form a circular shaped ring in a “dotted line” pattern. This embodiment would have the same general shape and dimensions, but it would be made of multiple segments instead of one continuous ring. In either embodiment, the opening 14 of the worktop 10 is over the waste receptacle so that any waste may be dropped through it and into the receptacle. FIG. 1C shows a side view of one embodiment of the worktop 10.

This view shows the work surface 12 and the fastening ring 24. The ring 24 is shown with enough height to ensure that it does not shift off of the waste receptacle once it is in position. The height of the ring is used to hold the worktop in place on the waste receptacle.

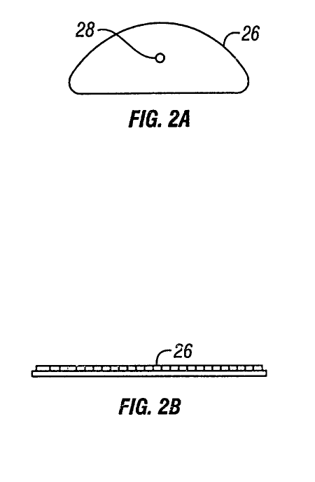

FIG. 2A shows an overhead view of an cover 26 for the opening 14 for use with the embodiment of the worktop 10 as shown in FIGS. 1A-1C. The cover 26 is used if waste disposal is not desired through the opening 14. The cover 26 completely fits over the opening 14 and extends the work surface 12 of the worktop 10. The cover 26 contains a fingerhole 28 to aid in its removal and attachment to the worktop 10. FIG. 2B shows a side view of the cover 26. If the cover 26 is in place because waste disposal is not desired, then the worktop 10 could be placed on top of another type of base such as a stool.

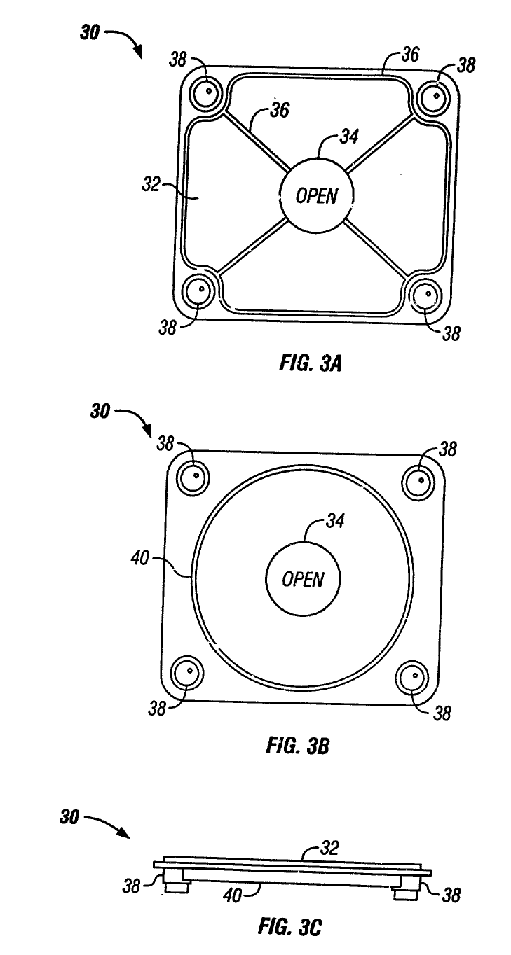

FIG. 3A shows an overhead view of an alternative embodiment of the worktop 30. This embodiment may serve as a dining top as well as a work surface. This embodiment of the worktop 30 includes a dining surface 32. An opening 34 is located in the center of worktop 30 for waste disposal. The exterior of the worktop 30 is surrounded with a drainage channel 36 that also extends towards the opening 34. Four separate cupholders 38 are shown in the corners of the worktop 30.

FIG. 3B shows a bottom view of the alternative embodiment of the worktop 30 shown in FIG. 3A. The previously described features including the opening 34 and the cupholders 38 are shown. Also shown is a fastening ring 40 that functions in the same manner as the ring previously shown in FIGS. 1A-1C. FIG. 3C shows a side view of the alternative embodiment of the worktop 30 shown in FIGS. 3A and 3B.

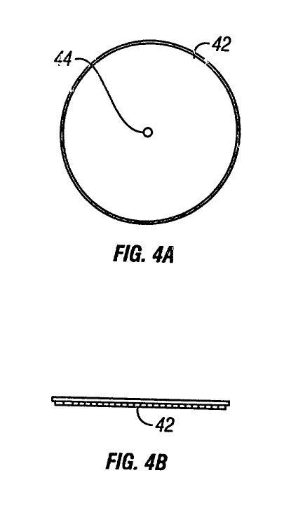

FIG. 4A shows an overhead view of a cover 42 for the opening for use with the embodiment of the worktop 30 shown in FIGS. 3A-3C. The cover 42 is designed to fit completely over the opening 34 of the work top 30 and extends the dining surface 32. The cover 42 includes a finger hole 44 to aid in removal and attachment of the cover 42 to the worktop 30. FIG. 4B shows a side view of the cover 42. If the cover 42 is in place because waste disposal is not desired, then the worktop 10 could be placed on top of another type of base such as a stool.

This embodiment is particularly adapted for serving as a dining top as well as a work surface. For example, eating shellfish such as shrimp, crabs or crawfish generates a waste. An individual could eat such food and use the opening to dispose of the waste to a receptacle located below. Since most of this type of food is moist, any fluid waste is contained by the drainage channels and directed through the opening. The extra cupholders provide a stable place to hold any condiments, etc. Alternatively, if waste disposal is not desired, the opening could used to hold a drop-in tray or bowl for dips, etc.

The advantages of the worktop includes providing a stable platform for either working or dining without the necessity of table legs. This make the worktop portable and convenient. The worktop may be fabricated out such materials as stainless steel, aluminum, wood, polyethylene, or other durable, UV stable plastics that are well known in the art. In alternative embodiments, the physical arrangement, shape and size of the features of the worktop could be varied.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A worktop, comprising:
a work surface;
an opening in the work surface; and
a fastening ring that detachably holds the worktop onto a stable base that completely supports the worktop, where the opening in the work surface is over the base so that the opening may be used for waste disposal.

2. The worktop of claim 1, where the base is a waste receptacle.

3. The worktop of claim 1, further comprising:
a removable cover for the opening.

4. The worktop of claim 1, further comprising:
a drainage channel located around the perimeter of the work surface.

5. The worktop of claim 4, where the drainage channel drains into the opening.

6. The worktop of claim 1, further comprising:
at least one cupholder on the work surface.

7. The worktop of claim 1, further comprising:
at least one slot in the work surface, where the slot is configured for holding a utensil.

8. The worktop of claim 1, further comprising:
an attachment in the work surface for a hose.

9. A worktop, comprising:
a work surface;
means for disposing of waste material through the work surface; and
means for detachably supporting the worktop.

10. The worktop of claim 9, further comprising:
means for containing liquid waste.

11. The worktop of claim 9, further comprising:
means for disposing of liquid waste.

12. The worktop of claim 9, further comprising:
means for removably closing the means for disposing of waste material through the work surface.
